(19) United States
(12) Patent Application Publication
(10) Pub. No.: US 2021/0231256 A1
(43) Pub. Date: Jul. 29, 2021

(54) Slip-On Splice-Filter Cage

(71) Applicant: PetroQuip Energy Services, LLC, Waller, TX (US)

(72) Inventors: Antonio Flores, Cypress, TX (US); Tracy Blanton, Magnolia, TX (US)

(73) Assignee: PetroQuip Energy Services, LLC, Waller, TX (US)

(21) Appl. No.: 17/160,024

(22) Filed: Jan. 27, 2021

Related U.S. Application Data
(60) Provisional application No. 62/966,265, filed on Jan. 27, 2020.

(51) Int. Cl. F16L 57/06; B01D 35/31; E21B 17/04

(52) U.S. Cl. CPC F16L 57/06; B01D 2201/301; E21B 17/04; B01D 35/31

(57) ABSTRACT

One or more specific embodiments disclosed herein may include a slip-on splice cage for conduits and filters, comprising a tubular housing adapted to be positioned around a tubular portion of a well string and a cover over at least a portion of the conduits, wherein the tubular housing may include one or more channels adapted to receive the conduits, and at least one hole positioned adjacent to each of the opposite ends of the tubular housing.

### CROSS-REFERENCE TO RELATED APPLICATIONS

This application claims priority to U.S. Provisional Patent Application No. 62/966,265 filed Jan. 27, 2020, the entire disclosures of which are incorporated herein by reference.

### BACKGROUND

### 1. Field of Inventions

The field of this application and any resulting patent is oil and gas communication. More specifically, this invention is in the technical field of organizing control lines and filtering the fluids transmitted in the control lines of a subsurface well.

### 2. Description of Related Art

In the process of production of oil and gas, some downhole tools may be controlled hydraulically by fluid transmitted from the surface by long metal control lines. The long distance that a control line may need to travel dictates that there may be splices (connections) along the length of the control line. The hydraulic fluid employed may be filtered to maintain its effectiveness downhole; therefore, downhole filters may be employed. Since both the splice and the filter may be larger in diameter than the control line itself, the splice and filter portions of the control line may need to be protected by a section of pipe called a splice sub. The splice sub may thread into the tubing string and provide an area for the splice and/or filter to be placed, protecting the splice and/or filter from rubbing along the casing inside the wellbore while being installed. This invention reduces the need for the large threads on splice subs while reducing the cost of the splice subs by utilizing a slip-on cage design.

Various devices and tools have been proposed and utilized for protecting control line splices and/or filters for hydraulic fluid, including some of the devices and tools in the references appearing on the face of this patent. However, those devices and tools lack all the steps or features of the devices and tools covered by any patent claims below. As will be apparent to a person of ordinary skill in the art, any devices and tools covered by claims of the issued patent solve many of the problems that prior art devices and tools have failed to solve. Also, the devices and tools covered by at least some of the claims of this patent have benefits that could be surprising and unexpected to a person of ordinary skill in the art based on the prior art existing at the time of invention. Some presently known benefits are as follows.

Embodiments of the invention remove the large threaded-on splice sub and replace the splice sub with a much smaller, more convenient slip-on splice-filter cage. Since the cage slips onto the outer diameter of the tubing, the cage is not weight dependent like the threaded-on splice sub is. In the oil industry, each size of tubing/casing (from now on will be referred to as tubing) has multiple weights. For example, the 5½″ tubing is always 5½″ in outer diameter, but each weight has a different inner diameter (17#=4.892″, 20#=4.778″, 23#=4.670″, 26#=4.548″). Because of the different weights, the operator and the supply (service) company must manufacture different splice subs for each weight—thus increasing the price and complexity of the splice sub. Since this splice sub is an integral part of the tubing string, the splice sub must carry the same load as the rest of the tubing. Therefore, the same inner diameter, outer diameter, and material must be maintained. Embodiments of this slip-on cage will protect the splice and/or filter, just as the existing, threaded-on splice sub does. Slip-on means that the cage rides on the outer diameter of the tubing to protect the splice and/or filter and that the cage may not be an integral part of the tubing string. Thus, the slip-on cage is easier to manufacture and more economical.

Thus, one advantage is the increase in reliability. The integrity of the tubing string will not be compromised by a 4 to 6-foot section of pipe that carries a splice or filter. Embodiments of the slip-on splice-filter cage may be attached to the outer diameter of the tubing, which maintains the integrity of the tubing string.

Another advantage is the adaptability of the design. Embodiments of the slip-on splice-filter cage work on all weights of the same tubing size. The orientation is unlimited since the slip-on splice-filter cage is held in place with screws around the outer diameter of the tubing. This orientation reduces stress on the control line and the connections.

Further, a third advantage is reduction of inventory for both the service company and the oil company. Since one size will fit every weight of each sized tubing, the amount of splice subs is needed to be carried in inventory is reduced, which reduces the overall cost.

Additionally, a fourth advantage is that since the slip-on splice-filter cage rides on the outer diameter of the tubing and is not an integral part of the tubing, the slip-on splice-filter cage material does not encounter the wellbore fluids. Therefore, the material of the slip-on splice-filter cage does not typically need to be as exotic as the tubing material, which makes the slip-on splice-filter cage less expensive.

### SUMMARY

One or more specific embodiments disclosed herein may include a slip-on splice cage for conduits and filters, comprising a tubular housing adapted to be positioned around a tubular portion of a well string and a cover over at least a portion of the conduits, wherein the tubular housing may include one or more channels adapted to receive the conduits, and at least one hole positioned adjacent to each of the opposite ends of the tubular housing.

### BRIEF DESCRIPTION OF THE DRAWINGS

FIG. 1 illustrates a perspective view of a cage according to an embodiment of the invention.

FIG. 2 illustrates a perspective view of the embodiment of FIG. 1 positioned on a tubular.

FIG. 3 illustrates a cross-sectional view of the embodiment of FIG. 2.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology.

### 2. Certain Specific Embodiments

Now, certain specific embodiments are described, which are by no means an exclusive description of the inventions. Other specific embodiments, including those referenced in the drawings, are encompassed by this application and any patent that issues therefrom.

One or more specific embodiments disclosed herein may include a slip-on splice cage for conduits and filters, comprising a tubular housing adapted to be positioned around a tubular portion of a well string and a cover over at least a portion of the conduits, wherein the tubular housing may include one or more channels adapted to receive the conduits, and at least one hole positioned adjacent to each of the opposite ends of the tubular housing.

In any one of the tools or devices disclosed herein, the at least one hole comprises threading.

In any one of the tools or devices disclosed herein, the at least one hole comprising threading is adapted to receive a screw.

In any one of the tools or devices disclosed herein, the screw comprises a grub screw.

In any one of the tools or devices disclosed herein, each of the opposite ends of the tubular housing comprise two beveled ends.

In any one of the tools or devices disclosed herein, each of the two beveled ends comprise one or more slots.

In any one of the tools or devices disclosed herein, one of the one or more slots lines up with one of the one or more channels.

In any one of the tools or devices disclosed herein, the cover is adapted to receive one or more fasteners.

In any one of the tools or devices disclosed herein, the cover is removably attached to the tubular housing.

In any one of the tools or devices disclosed herein, the tubular housing further comprises a plurality of recesses formed on the outer surface of the tubular housing.

In any one of the tools or devices disclosed herein, each of the plurality of recesses comprises a sheet of metal.

In any one of the tools or devices disclosed herein, the cover is positioned within the plurality of recesses formed in the outer surface of the tubular housing so as to be flush within the outer surface of the tubular housing.

### 3. Specific Embodiments in the Figures

The drawings presented herein are for illustrative purposes only and are not intended to limit the scope of the claims. Rather, the drawings are intended to help enable one having ordinary skill in the art to make and use the claimed inventions.

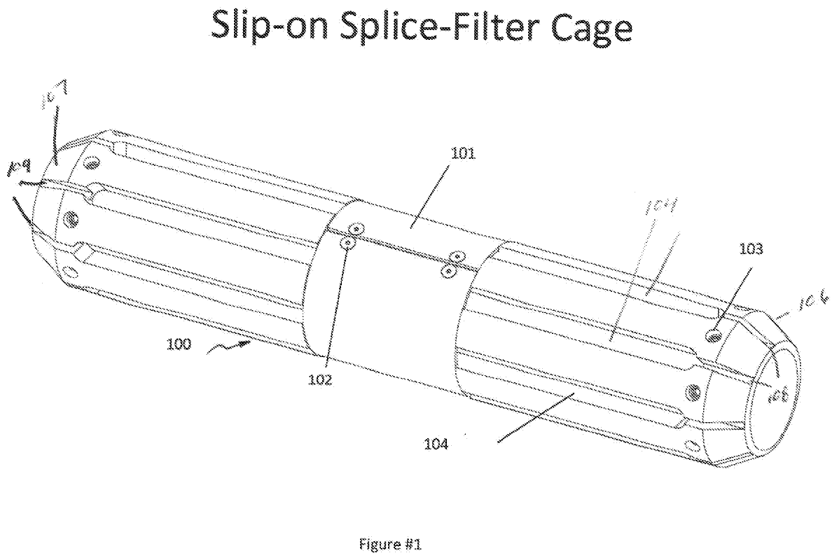

Referring to FIGS. 1-3, a specific embodiment, e.g., version or example, of a slip-on splice-filter cage is illustrated. These figures may show features which may be found in various specific embodiments, including the embodiments shown in this specification and those not shown.

FIG. 1 shows an embodiment of a slip-on splice-filter cage 100, which is not installed on a section of tubing. In embodiments, the slip-on splice-filter cage 100 may comprise a cover plate 101, one or more channels 104, and beveled end portions 106, 107. In embodiments, the cover plate 101, which protects the control line splice and/or hydraulic fluid filter, may be held in place on the cage 100 with one or more retaining screws 102. Further, in embodiments, the one or more channels 104 may provide space for the installation of the control line splices or hydraulic fluid filters (not illustrated). Additionally, in embodiments, the beveled end portions 106, 107 may comprise a plurality of slots 108, 109, respectively. In embodiments, the plurality of slots 108, 109 may lead into the one or more channels 104. Alternatively, in embodiments the ends of the cage 100 may not be beveled end portions 106, 107. In alternative embodiments, the ends of the cage 100 may be any shape that minimizes the amount of force to be overcome upon entering the well. For example, one alternative shape for one or both ends of the cage 100 may be a rounded shape.

FIG. 2 shows an embodiment of the cage 100 installed on a tubing 200. In embodiments, one or more grub screws 103 may be employed to thread down the cage 100 against the tubing 200, which may hold the cage 100 in place rotationally and axially.

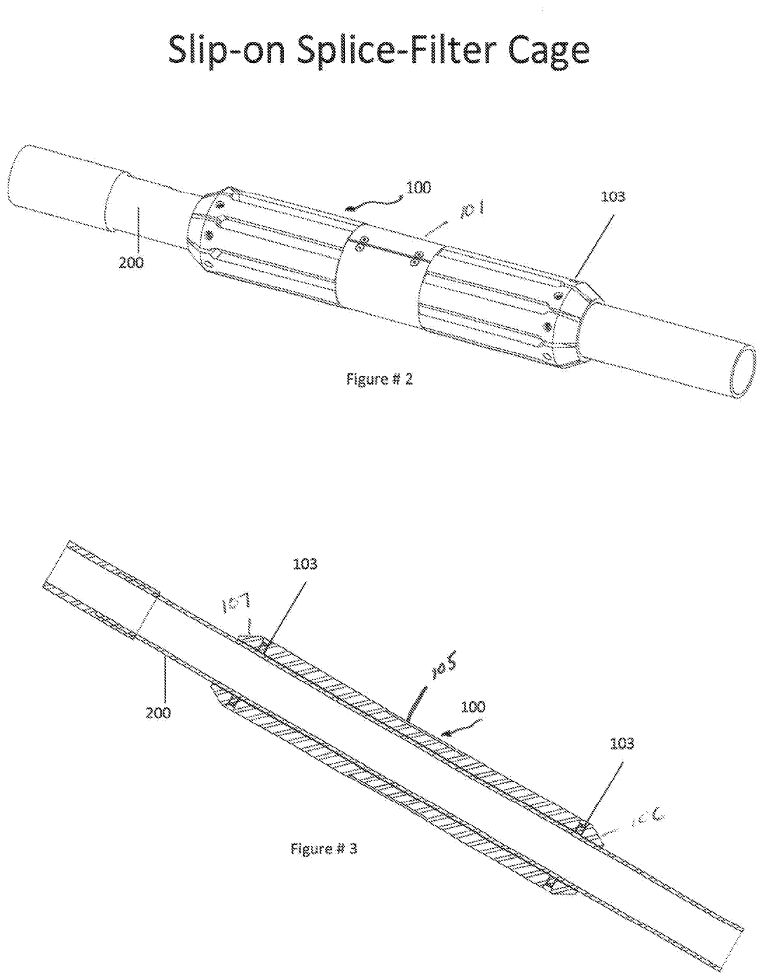

FIG. 3 shows an embodiment wherein the tubing 200 extends through the cage 100. In embodiments, the cover plate 100 may fit flush within a recess 105, which may be formed in the outer surface of the cage 100, and which may further be fabricated from a sheet of flexible metal, for example.

In embodiments, the cage 100 may be installed over the tubing 200 as the tubing 200 and control lines (not illustrated) are run in the well. In embodiments, on the rig floor, as a splice or filter is needed, the cage 100 may be positioned on the outer diameter of the tubing 200, and the splice is made in the control line, or the filter installed on the control line. In embodiments, the filter or splice may then be positioned in one of the channels of the cage 100. In embodiments, since the cage 100 is free to rotate on the tubing 200, it is easy to position the splice or filter in one of the one or more channels 104 of the cage 100. This ease of orientation minimizes the twist of the control lines around the tubing 200 and reduces the stress on the splices of the control lines. In embodiments, once everything is positioned correctly, the cage 100 may be held in position with the grub screws 103, such as set screws or grub screws, that may be tightened against the outer diameter of the tubing 200. Alternatively, the grub screws 103 may be replaced by any type of set screw. In embodiments, the tubing 200 may then be run downhole until another splice or filter is needed.

Although the present invention and its advantages have been described in detail, it should be understood that various changes, substitutions and alterations may be made herein without departing from the spirit and scope of the invention as defined by the appended claims.

What is claimed is:

1. A slip-on splice cage for conduits and filters, comprising:
a tubular housing adapted to be positioned around a tubular portion of a well string,
wherein the tubular housing comprises:
one or more channels adapted to receive the conduits, and
at least one hole positioned adjacent to each of the opposite ends of the tubular housing; and
a cover positioned over at least a portion of the conduits.

2. The slip-on splice cage of claim 1, wherein the at least one hole comprises threading.

3. The slip-on splice cage of claim 2, wherein the at least one hole comprising threading is adapted to receive a screw.

4. The slip-on splice cage of claim 3, wherein the screw comprises a grub screw.

5. The slip-on splice cage of claim 1, wherein each of the opposite ends of the tubular housing comprise two beveled ends.

6. The slip-on splice cage of claim 5, wherein each of the two beveled ends comprise one or more slots.

7. The slip-on splice cage of claim 6, wherein one of the one or more slots lines up with one of the one or more channels.

8. The slip-on splice cage of claim 1, wherein the cover is adapted to receive one or more fasteners.

9. The slip-on splice cage of claim 1, wherein the cover is removably attached to the tubular housing.

10. The slip-on splice cage of claim 1, wherein the tubular housing further comprises a plurality of recesses formed on the outer surface of the tubular housing.

11. The slip-on splice cage of claim 10, wherein each of the plurality of recesses comprises a sheet of metal.

12. The slip-on splice cage of claim 10, wherein the cover is positioned within the plurality of recesses formed in the outer surface of the tubular housing so as to be flush within the outer surface of the tubular housing.
